(19) United States
(12) Patent Application Publication
(10) Pub. No.: US 2026/0116788 A1
(43) Pub. Date: Apr. 30, 2026

(54) LOW SHEAR ION EXCHANGE SYSTEM FOR ENHANCING SELECTIVITY AND EFFICIENCY

(71) Applicant: A1 Lithium Inc., Las Vegas, NV (US)

(72) Inventor: Roshan Jeet Jee Jachuck, Boca Raton, FL (US)

(73) Assignee: A1 Lithium Inc., Las Vegas, NV (US)

(21) Appl. No.: 19/375,627

(22) Filed: Oct. 31, 2025

Related U.S. Application Data
(60) Provisional application No. 63/714,706, filed on Oct. 31, 2024.

(51) Int. Cl. C02F 1/42; C02F 101/10

(52) U.S. Cl. CPC C02F 1/42; C02F 2101/10; C02F 2201/002

(57) ABSTRACT

A controlled shear ion exchange system configured to create a low controllable shear between the processing fluid and the ion exchange resin is disclosed. The controlled shear ion exchange system may be configured for direct lithium extraction (DLE), separation of rare earth elements (REE), critical minerals and any other material desired to be separated from a fluid such as via ion exchange processes used for purification applications. The system may be desired to operate under low shear conditions between the fluid and the boundary wall of the solid resin particles, to selectively increase the adsorption of lithium ions onto the surface (pores) of the resin, while minimizing the adsorption of impurities such as magnesium, calcium, potassium, and sodium salts onto the resin. The system may also provide uniform wetting of the resin bed, thereby giving every molecule of the processing fluid the same contact (residence) time with the resin particles.

### CROSS-REFERENCE TO RELATED APPLICATION

This application claims the benefit of U.S. Provisional Patent Application No. 63/714,706, filed on Oct. 31, 2024, all of which are incorporated herein in their entireties.

### BACKGROUND

The disclosure relates to the selective production of battery grade lithium compounds in particular and generally to purification of water or recovery of high value compounds from brine or suitable fluids.

Direct lithium extraction (DLE) is a sustainable approach for extracting lithium from brines. This method selectively removes lithium from brines which contain several impurities. Typically, lithium ions are adsorbed on to the surface of resins (or beads) and subsequently desorbed along with minor impurities by the wash fluid which may be water or a liquid with a pre-defined pH. The desorbed lithium in the wash fluid is purified using advanced membrane technology and may be concentrated using an evaporator. Lithium in the form of lithium chloride is then reacted to form lithium carbonate, lithium phosphate or lithium hydroxide or other types of lithium compounds.

Conventional DLE systems, as shown in FIG. 1, are cylindrical columns which are packed with DLE resins. Brine or processing fluid enters at the bottom of the column and flows through the resin bed and exits at the top or vice versa. The brine is processed by creating a target pressure drop by throttling the flow through the cylindrical column. In a tall DLE column, the weight of the resin bed coupled with the packing density of the resin creates a considerable pressure drop on the brine, which makes the process energy intensive, and thus expensive. Thus, a more efficient system for processing lithium within brines is needed.

### SUMMARY

A controlled shear ion exchange system configured to create a low controllable shear between the processing fluid and the ion exchange resin is disclosed. The controlled shear ion exchange system may be configured for direct lithium extraction, separation of rare earth elements (REE), critical minerals and any other material desired to be separated from a fluid. In at least one embodiment, the controlled shear ion exchange system may be particularly suited for DLE processes, while also being suitable for conventional ion exchange processes used for purification applications. For certain ion exchange processes, and particularly for DLE systems, it may be desired to operate under low shear conditions between the fluid and the boundary wall of the solid resin particles, to selectively increase the adsorption of lithium ions onto the surface (pores) of the resin, while minimizing the adsorption of impurities such as magnesium, calcium, potassium, and sodium salts onto the resin. It may be also desired to ensure uniform wetting of the resin bed, thereby giving every molecule of the fluid (brine in the case of DLE process) the same contact (residence) time with the resin particles which may be in the form of beads or particles having any desired shape and size. Providing the processing fluid with the above-described hydrodynamic characteristics while encountering significantly low pressure drop as it flows through the resin bed or through a series of beds results in a controlled shear ion exchange system which will be energy efficient due to reduced pumping power cost.

In at least one embodiment, the controlled shear ion exchange system may include one or more processing fluid supply manifolds configured to supply processing fluid to one or more resin beds contained within an open chamber and configured to receive a processing fluid from the processing fluid supply manifold. The controlled shear ion exchange system may process the processing fluid by contacting the processing fluid with one or more resin beds without any external force added. In particular, the processing fluid may contact the resin bed under one gravity of pressure.

In at least one embodiment, the controlled shear ion exchange system may include one or more processing fluid supply manifolds. The controlled shear ion exchange system may include one or more first open chambers configured to support at least one resin bed and receive a processing fluid from the at least one processing fluid supply manifold. The controlled shear ion exchange system may include one or more second open chamber configured to support at least one resin bed and receive a processing fluid from the first open chamber. The processing fluid may contact the resin bed under one gravity of pressure. The flow of the processing fluid from the first open chamber to the second open chamber may be via gravity and without other pressure.

The first open chamber may be positioned higher than the second open chamber. In at least one embodiment, the first open chamber may be positioned above the second open chamber. The number of first and second open chambers included within a system may be determined by identifying a target residence time of the processing fluid in the resin beds.

The controlled shear ion exchange system may also be configured such that the first open chamber has a semi-circular cross-section configured to support the at least one resin bed while receiving processing fluid through an upper opening. The first open chamber may have one or more exhaust outlets configured to allow the processing fluid to be released from the chamber while achieving uniform wetting of resin in the resin bed and continuous discharge of the processing fluid to the second open chamber. The processing fluid may contact the resin bed under one gravity of pressure. The number of first and second open chambers included within a system may be determined by identifying a target residence time of the processing fluid in the resin beds.

The controlled shear ion exchange system may also include one or more resin restraint devices configured to prevent resin from being exhausted out of an exhaust outlet in the first open chamber. The exhaust outlet may be formed from one or more orifices positioned along a length of the first open chamber. The resin restraint device may be a mesh or other appropriate material for restraining resin in the resin bed while also enabling processing fluid to pass through the resin restraint device via one gravity.

The controlled shear ion exchange system may also include one or more overflow recapture systems configured to recapture any processing fluid overflow into a downstream open chamber by positioning each successive open chamber immediately below another chamber. The controlled shear ion exchange system may include a processed fluid collector configured to collect the processed fluid output from the second open chamber. The controlled shear ion exchange system may include a recirculation system including one or more pumps configured to pump the processed fluid from the processed fluid collector to the processing fluid supply manifold for reprocessing. The controlled shear ion exchange system may also include one or more processors in communication with one or more sensors configured to be in communication with the processed fluid in the processed fluid collector to determine whether an objective target processing has been achieved of the processing fluid. The processor may be configured such that if the objective target processing has been achieved, then the processor can operate one or more valves in the processed fluid collector to discharge the processed fluid. Conversely, the processor may be configured such that if the objective target processing has not been achieved, then the processor can operate at the pump in communication with the processed fluid in the processed fluid collector to pump the processed fluid to the processing fluid supply manifold for reprocessing.

An advantage of this system is that the controlled shear ion exchange system may be used for direct lithium extraction to extract lithium from brines at a rate higher than conventional systems.

Another advantage of this system is that the system in energy efficient only using processing fluid at one gravity of pressure, which creates better results with better efficiency.

Yet another advantage of this system is that the controlled shear ion exchange system has consistently achieved a Li/TDS ratio in excess of 0.08 using the controlled shear ion exchange system 10 disclosed herein, which is significantly better than achievable via conventional technology. Such Li/TDS ratio requires simpler downstream process configuration which improves process efficiency and reduces capital expenditures in lithium processing.

These and other embodiments are described in more detail below.

### BRIEF DESCRIPTION OF THE FIGURES

FIG. 1 is a schematic diagram of a conventional DLE column system in which pressure is used flow the brine through the resin column.

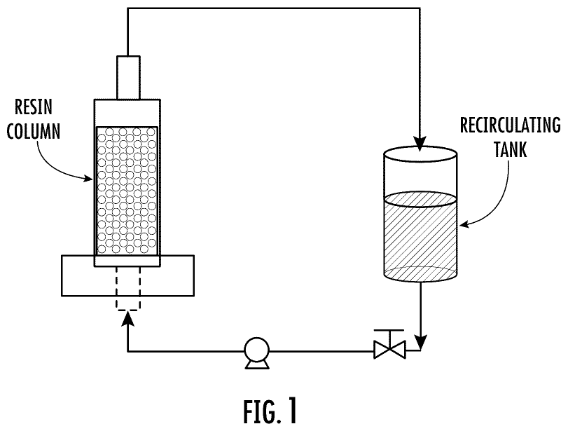

FIG. 2 is a schematic diagram of the low shear ion exchange system.

FIG. 3 is a perspective view of the low shear ion exchange system of FIG. 2.

FIG. 4 is a cross-sectional view of the low shear ion exchange system taken along section 4-4 in FIG. 3.

FIG. 5 is a flow chart of a method of creating a low controllable shear between a processing fluid and an ion exchange resin for direct lithium extraction and other ion exchange processes used for purification applications.

### DETAILED DESCRIPTION OF THE FIGURES

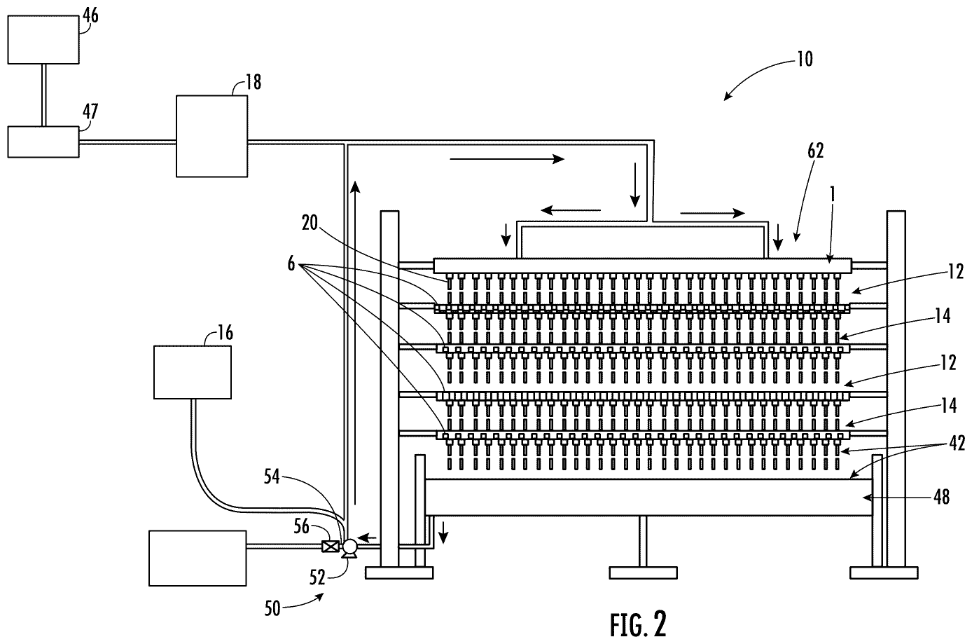

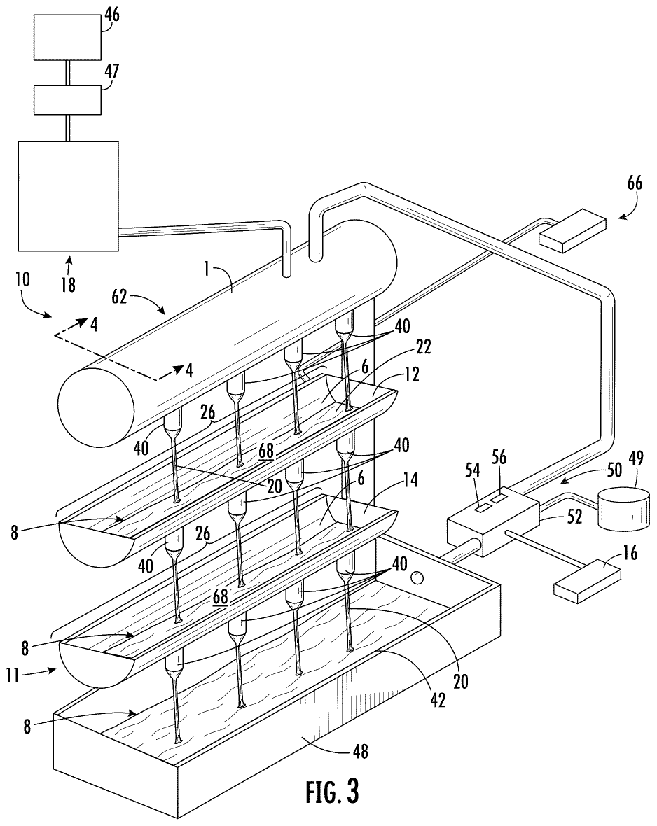

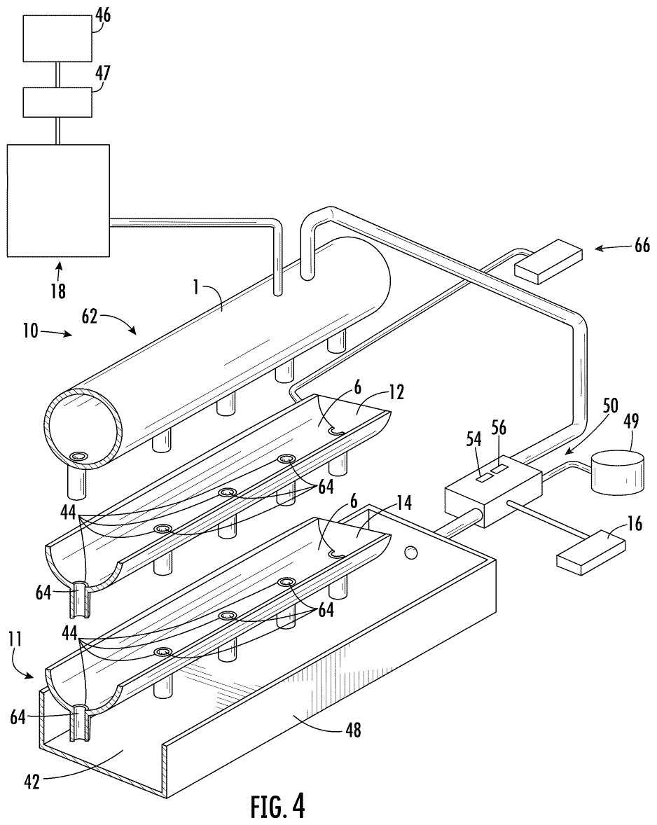

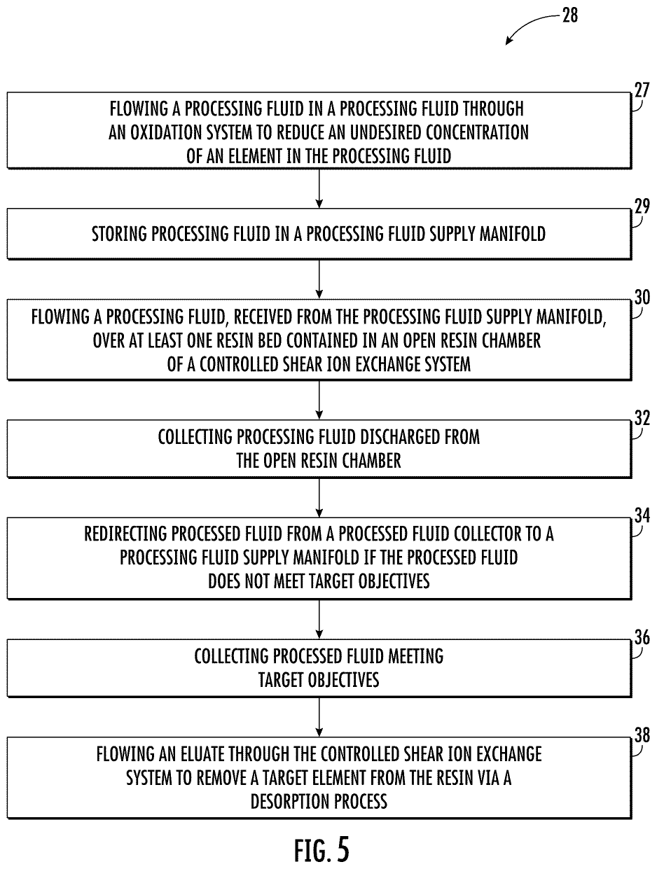

As shown in FIGS. 2-5, a controlled shear ion exchange system 10 configured to create a low controllable shear between a processing fluid 20 and an ion exchange resin is disclosed. The controlled shear ion exchange system 10 may be configured for direct lithium extraction, separation of rare earth elements (REE), critical minerals and any other material desired to be separated from a fluid. In at least one embodiment, the controlled shear ion exchange system 10 may be particularly suited for DLE processes, while also being suitable for conventional ion exchange processes used for purification applications. For certain ion exchange processes, and particularly for DLE systems, it may be desired to operate under low shear conditions between the processing fluid 20 and a boundary wall of solid resin particles to selectively increase the adsorption of lithium ions onto the surface (pores) of the resin 13 while minimizing the adsorption of impurities such as magnesium, calcium, potassium, and sodium salts onto the resin. The controlled shear ion exchange system 10 also ensures uniform wetting of the resin bed 8, thereby giving every molecule of the processing fluid 20, which may be, but is not limited to being, a brine in the case of a DLE process, the same contact (residence) time with the resin particles 13 which may be in the form of beads or particles having any desired shape and size. Providing the processing fluid 20 with the above-described hydrodynamic characteristics while encountering significantly low pressure drop as it flows through the resin bed 8 or through a series of resin beds 8 results in a controlled shear ion exchange system 10 which is energy efficient because less power is required due to less pumping being needed. Such reduction in power results in a lower power cost of operating the controlled shear ion exchange system 10 as compared with conventional systems.

In at least one embodiment, the controlled shear ion exchange system 10 may include one or more processing fluid supply manifolds 1 configured to supply processing fluid 20 to one or more resin beds 8 contained within an open chamber 6 and configured to receive a processing fluid 20 from the processing fluid supply manifold 1. The controlled shear ion exchange system 10 may process the processing fluid 20 by contacting the processing fluid 20 with one or more resin beds 8 without any external force added. In particular, the processing fluid 20 may contact the resin bed 8 under one gravity of pressure. As such, the processing fluids 20 flows through the controlled shear ion exchange system 10 via gravity.

The controlled shear ion exchange system 10, as shown in FIG. 2, comprises of a processed fluid collector 48, which bay be a container having an opening and used for recirculating the processing fluid 20, which may be a brine or wash water, a feed distributor system 62, capable of distributing the processing fluid 20 uniformly along the length of the resin packed open chamber 6, which may be, but is not limited to, having an elongated, semi-cylindrical shape. The open chambers 6 may be packed with resin material 8 which may be held in place by using a resin restraint device 44, which may be, but is not limited to being, a mesh. The mesh 44 may prevent resin from flowing out of distributor channels 64 located on the underside of the open chambers 6. Brine processing fluid 20 flows from the top processing fluid supply manifold 1, which is a processing fluid supply manifold 1, into an open chamber 6, which may be, but is not limited to being, a semi-cylindrical packed resin open chamber 6. The brine processing fluid 20 may then flow out from the bottom through an exhaust outlet 40 into an open chamber 6 placed directly below it.

The processed fluid 42, which may be, but is not limited to being, a brine or wash water, similarly flows under 1 g force (gravity) from one packed column to the other and eventually discharges into the recirculating tank. After one pass of the processing fluid brine 20 through the resin beds 8 in the open chambers 6 and collected, such as, but not limited to, via a processed fluid collector 48, the processed fluid brine 42 may be pumped to the processing fluid supply manifold 1 to repeat the entire process. In particular, the processed fluid brine 42 may be pumped to the processing fluid supply manifold 1, which may be at the top of the controlled shear ion exchange system 1. The processing fluid 20 may uniformly contact the resin beds 8 and because the flow is purely due to one gravity (1g) force, the shear forces between the processing fluid 20 and the resin surface 68 in the resin beds 8 is very small. The shear force may be influenced by changing a flow rate for processing fluid 20. In at least one embodiment, increasing a flow rate for processing fluid 20 may increase the shear force between the processing fluid 20 and the resin surface 68 in the resin beds 8. The holding time of the processing fluid 20 in each open chamber 6 may be a function of a diameter of the one or more exhaust outlets 40, which may be nozzles, the feed flow rate and cross-sectional area of each open chamber 6. Contact time with the resin in each tray. A diameter of a nozzle 40 may be selected to ensure there is no resin loss through the nozzle 40. Hence, the nozzle diameter 40 may be smaller than the mean diameter of the resin particles or the bead diameter if beads are used to form the resin bed 8. In at least one embodiment, a nozzle diameter of an exhaust nozzle 40 may be between around 500 microns to 1 millimeter.

In at least one embodiment, the controlled shear ion exchange system 10 may include one or more processing fluid supply manifolds 1. The controlled shear ion exchange system 10 may include one or more first open chambers 12 configured to support at least one resin bed 8 and receive a processing fluid 20 from the at least one processing fluid supply manifold 1. In at least one embodiment, the one or more open chambers 6 configured to contain the resin 6 may be formed from, but is not limited to being, a plastic such as, but not limited to, a PVC, PE, CPVC or any other thermoplastic, a suitable ceramic material or a metal having good corrosion resistance properties. The controlled shear ion exchange system 10 may include one or more second open chamber 14 configured to support at least one resin bed 8 and receive a processing fluid 20 from the first open chamber 12. The processing fluid 20 may contact the resin bed 8 under one gravity of pressure. The flow of the processing fluid 20 from the first open chamber 12 to the second open chamber 14 may be via gravity and without other pressure.

The first open chamber 12 may be positioned higher than the second open chamber 14. In at least one embodiment, the first open chamber 12 may be positioned above the second open chamber 14. The number of first and second open chambers 12, 14 included within a system 10 may be determined by identifying a target residence time of the processing fluid 20 in the resin beds 8.

The controlled shear ion exchange system 10 may also be configured such that the first open chamber 12 has a semi-circular cross-section configured to support the at least one resin bed 8 while receiving processing fluid 20 through an upper opening. The first open chamber 12 may have one or more exhaust outlets 40 configured to allow the processing fluid 20 to be released from the chamber while achieving uniform wetting of resin in the resin bed 8 and continuous discharge of the processing fluid 20 to the second open chamber 14. The exhaust outlets 40 may be circular, oval or other appropriate shape. Typical diameters for the orifice may be between 100 microns to 1 cm, and, in at least one embodiment, may be between 0.5 mm and 1 mm. The processing fluid 20 may contact the resin bed 8 under one gravity of pressure or other pressures. The number of first and second open chambers 12, 14 included within a system may be determined by identifying a target residence time of the processing fluid 20 in the resin beds 8. The flow rate of processing fluid 20 may be adjusted so that the resin is always wetted. The level of the processing fluid 20 may be maintained at the top of the first and second open chambers 12, 14 but not overflowing. In the event, that the processing fluid 20 overflows an open chamber 6, a downstream open chamber 11 positioned below the open chamber 6 will catch the processing fluid 20, thereby preventing any loss.

The controlled shear ion exchange system 10 may also include one or more resin restraint devices 44 configured to prevent resin 13 from being exhausted out of an exhaust outlet 40 in the first open chamber 12. The exhaust outlet 40 may be formed from one or more orifices positioned along a length of the first open chamber 12. The resin restraint device 44 may be a mesh or other appropriate material for restraining resin 13 in the resin bed 8 while also enabling processing fluid 20 to pass through the resin restraint device 44 via one gravity. In at least one embodiment, the resin restraint device 44 may be formed from, but is not limited to being, a plastic or a metal that is chemically compatible with the processing fluid 20.

The controlled shear ion exchange system 10 may also include one or more overflow recapture systems 72 configured to recapture any processing fluid overflow into a downstream open chamber 11 by positioning each successive open chamber 6 immediately below another chamber 6. The controlled shear ion exchange system 10 may include a processed fluid collector 48 configured to collect the processed fluid 42 output from the second open chamber 14. The controlled shear ion exchange system 10 may include a recirculation system 50 including one or more pumps 52 configured to pump the processed fluid from the processed fluid collector 48 to the processing fluid supply manifold 1 for reprocessing. The controlled shear ion exchange system 10 may also include one or more processors 16 in communication with one or more sensors 54 configured to be in communication with the processed fluid in the processed fluid collector 48 to determine whether an objective target processing has been achieved of the processing fluid 20. The processor 16 may be configured such that if the objective target processing has been achieved, then the processor 16 can operate one or more valves 56 in the processed fluid collector 48 to discharge the processed fluid into a processed fluid tank 49. Conversely, the processor 16 may be configured such that if the objective target processing has not been achieved, then the processor 16 can operate at the pump in communication with the processed fluid 42 in the processed fluid collector 48 to pump the processed fluid 42 to the processing fluid supply manifold 1 for reprocessing.

The controlled shear ion exchange system 10 may be configured to process processing fluid 20 to achieve an objective target processing of the processing fluid 20. Typically, the raw brine has very high total dissolved solids (TDS), which are often more than 150,000 ppm together with a lithium concentration in the range of 50 ppm to 300 ppm. In some cases, the lithium concentration may be even higher. Brine processing fluid 20 may also have iron, generally in the form of ferrous oxide, with a concentration between about 3 ppm to about 100 ppm. Iron may have a detrimental effect in the longevity of the resin or resin beads used in the system 10. The brine processing fluid 20 may also contain bromides (around 60 ppm), sodium (around 40,000 ppm-70,000 ppm), calcium magnesium and potassium salts, sulphates and chloride ions.

The controlled shear ion exchange system 10 may be configured such that only lithium is absorbed by the resin 13 and the other ions, which are impurities, flow out of the system 10 and thereby becoming processed fluid 42, which is spent brine. While the controlled shear ion exchange system 10 is configured to selectively remove lithium ions from the raw brine processing fluid 20, often several other ions, which are impurities are also adsorbed, albeit in very low concentrations. Ideally, in one pass through the controlled shear ion exchange system 10, at least 95 percent of the lithium from the raw brine processing fluid 20 is adsorbed by the resin 13 forming the resin beds 8. If a single pass of processing fluid 20 through the controlled shear ion exchange system 10 does not yield removal of at least 95 percent of lithium from the processing fluid 20, then the processed fluid 42 may be passed through the controlled shear ion exchange system 10 two or more times to ensure that at least 95 percent of lithium is recovered from the initial processing fluid 20. In other embodiments, a target removal of lithium to achieve an objective target processing of the processing fluid 20 may be more or less than 95 percent lithium removal.

In certain cases, the feed brine processing fluid 20 may be heated to increase the adsorption efficiency. The temperature of the pre-heated brine processing fluid 20 depends on the nature of the resin 13 or beads used in the controlled shear ion exchange system 10. In at least one embodiment, the feed brine processing fluid 20 may be between about 50 degrees Celsius and 60 degrees Celsius to increase the adsorption efficiency. In at least one embodiment, highest energy efficiency is obtained with a feed brine processing fluid 20 having a temperature between 20 degrees Celsius and 35 degrees Celsius.

Once the controlled shear ion exchange system 10 has removed at least an objective target processing of the processing fluid 20, a desorption process may be performed by passing an eluate, such as, but not limited to deionized water (DI water), through the controlled shear ion exchange system 10 to remove lithium from the resin 13. After being passed through the controlled shear ion exchange system 10, the eluate may have a concentration of lithium that is greater than a lithium concentration of the processing fluid 20 before being passed through the controlled shear ion exchange system 10. In at least one embodiment, the eluate may have a concentration of lithium that is between 1.5 and 3 times a concentration of lithium in the feed brine processing fluid 20. As such, the controlled shear ion exchange system 10 is able to receive a processing fluid 20 with a lithium concentration and generate an eluate with fewer impurities than the feed brine processing fluid 20 and a lithium concentration that is between 1.5 and 3 times greater than a concentration of lithium in the feed brine processing fluid 20.

The controlled shear ion exchange system 10 may also include an oxidation system 46 that may be positioned upstream from the processing fluid supply manifold 1. The oxidation system 46 may be configured to remove or reduce a concentration of minerals from the processing fluid 20 before the processing fluid 20 enters the processing fluid supply manifold 1. For example, if an initial iron concentration is high in the feed brine processing fluid 20, such as above 1 ppm, the feed brine processing fluid 20 may be passed through the oxidation system 46, which may be, but is not limited to being, an electro-oxidation system 46, to remove the iron from the feed brine processing fluid 20. Once feed brine processing fluid 20 is passed through the electro-oxidation system 46, which is a chemical free approach for iron removal, an inline filtration system 47 may be used to produce a clean raw processing fluid 20 for use in the controlled shear ion exchange system 10.

In at least one embodiment, the one or more open chambers 6 configured to contain the resin may be formed from, but is not limited to being, a plastic such as, but not limited to, a PVC, PE, CPVC or any other thermoplastic, a suitable ceramic material or a metal having good corrosion resistance properties.

In at least one exemplary embodiment, the controlled shear ion exchange system 10 may be used for Direct Lithium Extraction to extract lithium from brines at a rate higher than conventional systems. Direct Lithium Extraction is a sustainable approach for extracting lithium from brines. This method selectively removes lithium from brines which contain several impurities. Typically, lithium ions are adsorbed on to the surface of resins (or beads) and subsequently desorbed along with minor impurities by the wash fluid which may be water or a liquid with a pre-defined pH. The desorbed lithium in the wash fluid is purified using advanced membrane technology in which IX resins and may be concentrated using an evaporator. Lithium in the form of lithium chloride is then reacted to form lithium carbonate or lithium hydroxide or other types of lithium compounds. Test data has demonstrated that using the controlled shear ion exchange system 10 can produce eluate with high Lithium to TDS (total dissolved salt) (Li/TDS) ratio via a desorption process. The controlled shear ion exchange system 10 has consistently achieved a Li/TDS ratio in excess of 0.08 using the controlled shear ion exchange system 10 disclosed herein, which is significantly better than achievable via conventional technology. Such Li/TDS ratio requires simpler downstream process configuration which improves process efficiency and reduces capital expenditures in lithium processing.

The controlled shear ion exchange system 10 shown in FIGS. 2-4, may be operated to generate high quality eluate. In particular, the controlled shear ion exchange system 10 may be used to brine a flow of the processing fluid 20 by passing the processing fluid 20 through the resin bed 8 in one or more open chambers 6 containing one or more resin beds 8. A short burst of deionized (DI) water flow may be injected from a deionized (DI) water injection system 66 into the open chambers 6, which may be, but are not limited to being, semi-cylindrical chambers, to remove impurities from the resin 13. The short burst of DI water flow may be followed by a controlled DI water flow to recover high purity lithium in the eluate. Once the lithium concentration in the eluate has dropped, then the cycle may be repeated all over again. In at least one embodiment, when using this method, the lithium concentration in the eluate was determined to be three times (3×) the initial lithium concentration in the processing fluid 20 (feed brine).

A method 28 of processing fluid 20 via controlled shear ion exchange system is disclosed. The method 28 may include at 27 flowing a processing fluid through an oxidation system 46 to reduce an undesired concentration of an element in the processing fluid 20. For instance, if an initial iron concentration is high in the feed brine processing fluid 20, such as above 1 ppm, the feed brine processing fluid 20 may be passed through the oxidation system 46, which may be, but is not limited to being, an electro-oxidation system 46, to remove the iron from the feed brine processing fluid 20. The method 28 may include at 29 storing processing fluid in a processing fluid supply manifold. The method 28 may also include flowing a processing fluid 20 at 30 over at least one resin bed 8 of a controlled shear ion exchange system 10. The controlled shear ion exchange system 10 may include one or more resin beds 8 and one or more open resin chambers 6 configured to support the resin bed 8 and to receive a processing fluid 20 from a processing fluid supply 18. The controlled shear ion exchange system 10 may be configured that the processing fluid 20 contacts the resin bed 8 without any external force added and becomes processed fluid. The method 28 may also include collecting at 32 processed fluid discharged from the open resin chamber 6.

The method 28 may also be configured such that flowing a processing fluid 20 over at least one resin bed 8 of a controlled shear ion exchange system 10 that includes a first open chamber 12 configured to support one or more first resin beds 22 and receive a processing fluid 20 from the processing fluid supply manifold 1 and a second open chamber 14 configured to support one or more second resin beds 24 and receive a processing fluid 20 from the first open chamber 12. The first open chamber 12 may be configured to support one or more resin beds 8 while receiving processing fluid 20 through an upper opening 26. The first open chamber 12 may include one or more exhaust outlets 40 configured to allow the processing fluid 20 to be released from the first open chamber 12 while achieving substantially uniform wetting of resin in the first resin bed 22 while discharging the processing fluid 20 to the second open chamber 14.

The method 28 may also include collecting at 34 processed fluid 42 discharged from the second open chamber 14. The step 34 of method 28 of collecting processed fluid discharged from the open resin chamber 6 may include collecting processed fluid via a processed fluid collector 48 configured to collect processed fluid output 42 from the second open chamber 14.

The method 28 may also include collecting at 36 processed fluid 42 meeting target objectives. The method 28 may include flowing at 38 an eluate through the controlled shear ion exchange system to remove a target element from the resin via a desorption process.

The step 30 of method 28 may also include flowing the processing fluid 20 over one or more resin beds 8, wherein the controlled shear ion exchange system 10 further comprises including a number of first and second open chambers 12, 14 configured to support the first and second resin beds 22, 24 in the controlled shear ion exchange system 10 based on a target residence time of the processing fluid 20 in the resin beds 22, 24.

The step 30 of method 28 may also include flowing the processing fluid 20 over one or more resin beds 8 of the controlled shear ion exchange system 10 including one or more resin restraint devices 44 configured to prevent resin from being exhausted out of an exhaust outlet 40. In at least one embodiment, the resin restraint devices 44 may be a mesh formed from any appropriate material which already exists or has yet to exist. The step 30 of method 28 may also include flowing the processing fluid 20 over one or more resin beds 8 of the controlled shear ion exchange system 10 including an overflow recapture system 72 configured to recapture any processing fluid 20 that overflows into a downstream open chamber 6 by positioning each successive open chamber 6 immediately below another chamber 6. The step 30 of method 28 may also be configured such that flowing a processing fluid 20 over at least one resin bed 8 of a controlled shear ion exchange system 10 including a recirculation system 50 formed from one or more pumps 52 configured to pump the processed fluid 42 from the processed fluid collector 48 to the processing fluid supply manifold 1 for reprocessing.

The step 30 of method 28 may also be configured such that flowing a processing fluid 20 over at least one resin bed 8 of a controlled shear ion exchange system 10 including one or more processors 16 in communication with one or more sensors 54 configured to be in communication with the processed fluid 42 in the processed fluid collector 48 to determine whether the processing fluid 20 achieves a target processing objective of the processing fluid 20. The step 30 of method 28 may also be configured such that flowing a processing fluid 20 over at least one resin bed 8 of a controlled shear ion exchange system 10 includes a processor 16 of the controlled shear ion exchange system 10 being configured such that if the objective target processing has been achieved, then the processor 16 controls one or more valves 56 in the processed fluid collector 48 to discharge the processing fluid 20. The step 30 of method 28 may also be configured such that flowing a processing fluid 20 over at least one resin bed 8 of a controlled shear ion exchange system 10 includes one or more processors 16 being configured such that if the objective target processing has not been achieved, then the processor 16 can operate at the pump 52 in communication with the processed fluid 42 in the processed fluid collector 48 to pump the processed fluid 42 to the processing fluid supply manifold 1 for reprocessing.

The step 30 of method 28 may also be configured such that flowing a processing fluid 20 over at least one resin bed 8 of a controlled shear ion exchange system 10 including a first open chamber 12 having a semi-circular cross-section configured to support the resin bed 8 while receiving processing fluid 20 through an upper opening 26.

The controlled shear ion exchange system 10 may also be suitable for applications in which challenging ion exchange (IX) separation is performed, such as, particularly for purification and separation of rare earth elements (REE) and critical minerals, such as, but not limited to critical materials that are non-fuel materials with high supply risk and materials that are essential for energy. In applications in which rare earth elements are processed, rare earth elements may be dissolved in a suitable solvent to form a processing fluid 20, which will flow under low shear and gravity flow conditions over IX resins 13, whereby the low shear conditions of the controlled shear ion exchange system 10 improve the selective adsorption of the elements. As with other applications set forth herein, one or more rare earth elements may be adsorbed by the IX resins 13 contained in the open chambers 6. Once a target processing objective of the processing fluid 20 has been achieved, the rare earth elements that have been adsorbed into the IX resins 13 may be removed from the IX resins 13 via desorption by flowing a fluid with less impurities, such as, but not limited to, deionized water over the resin 13 in the open chambers 6. The same procedure is also applicable for separation and purification of critical minerals.

The foregoing is provided for purposes of illustrating, explaining, and describing embodiments. Modifications and adaptations to these embodiments will be apparent to those skilled in the art.

I claim:

1. A controlled shear ion exchange system, comprising:
at least one resin bed;
at least one open resin chamber configured to support the at least one resin bed and to receive a processing fluid from at least one processing fluid supply; and
wherein the processing fluid contacts the at least one resin bed without any external force added.

2. The controlled shear ion exchange system of claim 1, whereby the processing fluid contacts the at least one resin bed under one gravity of pressure.

3. A controlled shear ion exchange system, comprising:
at least one processing fluid supply manifold;
a first open chamber configured to support at least one first resin bed and to receive a processing fluid from the at least one processing fluid supply manifold;
the at least one first resin bed supported by the first open chamber;
a second open chamber configured to support at least one second resin bed and receive a processing fluid from the first open chamber; and
the at least one second resin bed supported by the second open chamber.

4. The controlled shear ion exchange system of claim 3, whereby the processing fluid contacts the at least one first resin bed under one gravity of pressure.

5. The controlled shear ion exchange system of claim 3, wherein flow of the at least one processing fluid from the first open chamber to the second open chamber is via gravity and without other pressure.

6. The controlled shear ion exchange system of claim 3, wherein the first open chamber is positioned higher than the second open chamber.

7. The controlled shear ion exchange system of claim 3, wherein the first open chamber is positioned above the second open chamber.

8. The controlled shear ion exchange system of claim 3, wherein a number of first and second open chambers configured to support the at least one first and second resin beds is chosen to achieve a target residence time of the processing fluid in the resin beds.

9. A controlled shear ion exchange system, comprising:
at least one processing fluid supply manifold;
a first open chamber configured to support at least one first resin bed and receive a processing fluid from the at least one processing fluid supply manifold; and
a second open chamber configured to support at least one second resin bed and receive a processing fluid from the first open chamber;
wherein the first open chamber is configured to support the at least one resin bed while receiving processing fluid through an upper opening; and
wherein the first open chamber has at least one exhaust outlet configured to allow the processing fluid to be released from the first open chamber while achieving substantially uniform wetting of resin in the at least one first resin bed while discharging the processing fluid to the second open chamber.

10. The controlled shear ion exchange system of claim 9, whereby the processing fluid contacts the at least one first resin bed under one gravity of pressure.

11. The controlled shear ion exchange system of claim 9, wherein a number of first and second open chambers configured to support the at least one first and second resin beds is chosen to achieve a target residence time of the processing fluid in the resin beds.

12. The controlled shear ion exchange system of claim 9, further comprising at least one resin restraint device configured to prevent resin from being exhausted out of the at least one exhaust outlet.

13. The controlled shear ion exchange system of claim 12, wherein the at least one resin restraint device is a mesh.

14. The controlled shear ion exchange system of claim 9, further comprising an overflow recapture system configured to recapture any processing fluid that overflows into a downstream open chamber by positioning each successive open chamber immediately below another chamber.

15. The controlled shear ion exchange system of claim 9, further comprising a processed fluid collector configured to collect processed fluid output from the second open chamber.

16. The controlled shear ion exchange system of claim 15, further comprising a recirculation system comprising at least one pump configured to pump the processed fluid from the processed fluid collector to the at least one processing fluid supply manifold for reprocessing.

17. The controlled shear ion exchange system of claim 15, further comprising at least one processor in communication with at least one sensor configured to be in communication with the processed fluid in the processed fluid collector to determine whether the processing fluid achieves a target processing objective of the processing fluid.

18. The controlled shear ion exchange system of claim 15, wherein the at least one processor is configured such that if the objective target processing has been achieved, then the processor controls at least one valve in the processed fluid collector to discharge the processing fluid.

19. The controlled shear ion exchange system of claim 15, wherein the at least one processor is configured such that if the objective target processing has not been achieved, then the processor can operate at the pump in communication with the processed fluid in the processed fluid collector to pump the processed fluid to the at least one processing fluid supply manifold for reprocessing.

20. The controlled shear ion exchange system of claim 9, wherein the first open chamber has a semi-circular cross-section configured to support the at least one resin bed while receiving processing fluid through an upper opening.

21. The controlled shear ion exchange system of claim 1, further comprising an oxidation system positioned upstream from the at least one processing fluid supply manifold and configured to at least reduce a concentration of minerals from the processing fluid before the processing fluid enters the processing fluid supply manifold.

22. A method of processing fluid via controlled shear ion exchange system, comprising:
flowing a processing fluid over at least one resin bed of a controlled shear ion exchange system, wherein the controlled shear ion exchange system comprises:
the at least one resin bed;
at least one open resin chamber configured to support the at least one resin bed and to receive a processing fluid from at least one processing fluid supply; and
wherein the processing fluid contacts the at least one resin bed without any external force added and becomes processed fluid; and
collecting processed fluid discharged from the at least one open resin chamber.

23. The method of claim 22, wherein flowing a processing fluid over at least one resin bed of a controlled shear ion exchange system comprises flowing the processing fluid over at least one resin bed, wherein the controlled shear ion exchange system comprises:
a first open chamber configured to support at least one first resin bed and receive a processing fluid from the at least one processing fluid supply manifold; and
a second open chamber configured to support at least one second resin bed and receive a processing fluid from the first open chamber;
wherein the first open chamber is configured to support the at least one resin bed while receiving processing fluid through an upper opening; and
wherein the first open chamber has at least one exhaust outlet configured to allow the processing fluid to be released from the first open chamber while achieving substantially uniform wetting of resin in the at least one first resin bed while discharging the processing fluid to the second open chamber; and
wherein collecting processed fluid discharged from the at least one open resin chamber comprises collecting processed fluid discharged from the second open chamber.

24. The method of claim 23, wherein flowing a processing fluid over at least one resin bed of a controlled shear ion exchange system comprises flowing the processing fluid over at least one resin bed, wherein the controlled shear ion exchange system further comprises including a number of first and second open chambers configured to support the at least one first and second resin beds in the controlled shear ion exchange system based on a target residence time of the processing fluid in the resin beds.

25. The method of claim 23, wherein flowing a processing fluid over at least one resin bed of a controlled shear ion exchange system comprises flowing the processing fluid over at least one resin bed, wherein the controlled shear ion exchange system further comprises at least one resin restraint device configured to prevent resin from being exhausted out of the at least one exhaust outlet.

26. The method of claim 25, wherein the at least one resin restraint device is a mesh.

27. The method of claim 23, wherein collecting processed fluid discharged from the at least one open resin chamber comprises collecting processed fluid via a processed fluid collector configured to collect processed fluid output from the second open chamber.

28. The method of claim 23, wherein flowing a processing fluid over at least one resin bed of a controlled shear ion exchange system comprises flowing the processing fluid over at least one resin bed, wherein the controlled shear ion exchange system further comprises an overflow recapture system configured to recapture any processing fluid that overflows into a downstream open chamber by positioning each successive open chamber immediately below another chamber.

29. The method of claim 28, wherein flowing a processing fluid over at least one resin bed of a controlled shear ion exchange system comprises flowing the processing fluid over at least one resin bed, wherein the controlled shear ion exchange system further comprises a recirculation system comprising at least one pump configured to pump the processed fluid from the processed fluid collector to the at least one processing fluid supply for reprocessing.

30. The method of claim 28, wherein flowing a processing fluid over at least one resin bed of a controlled shear ion exchange system comprises flowing the processing fluid over at least one resin bed, wherein the controlled shear ion exchange system further comprises at least one processor in communication with at least one sensor configured to be in communication with the processed fluid in the processed fluid collector to determine whether the processing fluid achieves a target processing objective of the processing fluid.

31. The method of claim 28, wherein flowing a processing fluid over at least one resin bed of a controlled shear ion exchange system comprises flowing the processing fluid over at least one resin bed, wherein the at least one processor of the controlled shear ion exchange system is configured such that if the objective target processing has been achieved, then the processor controls at least one valve in the processed fluid collector to discharge the processing fluid.

32. The method of claim 28, wherein flowing a processing fluid over at least one resin bed of a controlled shear ion exchange system comprises flowing the processing fluid over at least one resin bed, wherein the at least one processor is configured such that if the objective target processing has not been achieved, then the processor can operate at the pump in communication with the processed fluid in the processed fluid collector to pump the processed fluid to the at least one processing fluid supply manifold for reprocessing.

33. The method of claim 23, wherein flowing a processing fluid over at least one resin bed of a controlled shear ion exchange system comprises flowing the processing fluid over at least one resin bed, wherein the first open chamber has a semi-circular cross-section configured to support the at least one resin bed while receiving processing fluid through an upper opening.
